(19) United States
(12) Patent Application Publication
(10) Pub. No.: US 2023/0334766 A1
(43) Pub. Date: Oct. 19, 2023

(54) INFORMATION PROCESSING APPARATUS, INFORMATION PROCESSING METHOD, IMAGE PROCESSING SYSTEM, AND STORAGE MEDIUM

(71) Applicant: CANON KABUSHIKI KAISHA, Tokyo (JP)

(72) Inventor: Fumihiro KAJIMURA, Tokyo (JP)

(21) Appl. No.: 18/298,410

(22) Filed: Apr. 11, 2023

(30) Foreign Application Priority Data
Apr. 15, 2022 (JP) 2022-067856

(51) Int. Cl. G06T 15/20; G06T 7/73

(52) U.S. Cl. CPC G06T 15/20; G06T 7/74

(57) ABSTRACT

The degree of similarity calculation unit calculates the degree of similarity between the virtual viewpoint parameters of the virtual viewpoint operated by its own apparatus and the virtual viewpoint parameters of another virtual viewpoint and in a case where it is determined that the degree of similarity satisfies a similarity condition determined in advance, the control unit causes the display of the image display unit to be changed. For example, the warning display for giving a notification that another virtual viewpoint whose virtual viewpoint parameters are similar exists and the image capturing frame of the other similar virtual viewpoint are displayed together with the virtual viewpoint image representing the appearance from the virtual viewpoint operated by the operator him/herself.

### BACKGROUND

### Field

The present disclosure relates to an information processing technique for assisting in operating a virtual viewpoint.

### Description of the Related Art

In recent years, a system has been proposed, which generates a virtual viewpoint image representing an appearance from a virtual viewpoint designated by a user based on a plurality of captured images obtained by a plurality of imaging devices. This virtual viewpoint image is generated by aggregating a plurality of captured images obtained from a plurality of imaging devices in an image processing apparatus, such as a server, and performing rendering in the image processing apparatus based on a virtual viewpoint capable of moving freely within a three-dimensional space corresponding to an image capturing space. The generated virtual viewpoint image is transmitted from the image processing apparatus to an information processing terminal of a user and it is possible for the user to display and browse the received virtual viewpoint image on the information processing terminal.

It is possible for the image processing apparatus to simultaneously generate a plurality of virtual viewpoint images corresponding to a plurality of virtual viewpoints operated by a plurality of operators by connecting a plurality of information processing terminals for operating virtual viewpoints. Japanese Patent Laid-Open No. 2019-079298 has disclosed a technique to generate a plurality of virtual viewpoint images in accordance with a plurality of virtual viewpoints operated by a plurality of operators. It is possible for each operator to perform the operation while checking the virtual viewpoint operated by another operator by displaying information relating to the virtual viewpoint of the other operator on the operation screen. In a case where this technique is used for sports broadcast, it is considered that a production side causes each of a plurality of operators to generate a different virtual viewpoint image, selects a virtual viewpoint image to be provided to viewers from among a plurality of generated virtual viewpoint images, and provides a variety of virtual viewpoint image to viewers while switching them.

However, the technique of Japanese Patent Laid-Open No. 2019-079298 presents information relating to a virtual viewpoint operated by another operator, but it is necessary for the operator to determine whether or not there exists another virtual viewpoint similar to the virtual viewpoint operated by the operator him/herself. In a case where the movement of a target object is quick and prediction is difficult to make as in sports broadcast, there is no choice for the operator but to concentrate on the operation of the virtual viewpoint, and therefore, it is difficult to grasp similarity to another virtual viewpoint and it may happen sometimes that a similar virtual viewpoint is set. As a result of that, there is case where a similar virtual viewpoint image is generated and the number of variations of virtual viewpoint image is reduced.

Consequently, an object of the present disclosure is to make it unlikely that similar virtual viewpoint images are generated at the time of generating a plurality of virtual viewpoint images based on a plurality of virtual viewpoints.

### SUMMARY

The present disclosure is an information processing apparatus including: one or more processors; at least one memory coupled to the one or more processors storing instructions that, when executed by the one or more processors, cause the one or more processors to function as: a parameter obtaining unit configured to obtain virtual viewpoint parameters specifying each virtual viewpoint of a plurality of virtual viewpoints; and a notification unit configured to give a notification that a similar virtual viewpoint exists in a case where there are virtual viewpoint parameters of a second virtual viewpoint different from a first virtual viewpoint, which indicate a position and an orientation similar to at least a position and an orientation indicated by virtual viewpoint parameters of the first virtual viewpoint, among virtual viewpoint parameters of a plurality of virtual viewpoint parameters, which indicate a time identical to a time indicated by the virtual viewpoint parameter of the first virtual viewpoint among the plurality of virtual viewpoint parameters obtained by the parameter obtaining unit.

Further features of the present disclosure will become apparent from the following description of exemplary embodiments with reference to the attached drawings.

### BRIEF DESCRIPTION OF THE DRAWINGS

FIG. 1A is a schematic diagram of an entire image processing system in a first embodiment;

FIG. 1B is a block diagram of the entire image processing system in the first embodiment;

FIG. 2A is a schematic diagram of an information processing apparatus in the first embodiment;

FIG. 2B is a block diagram of the information processing apparatus in the first embodiment;

FIG. 2C is a block diagram showing a hardware configuration of a processing unit in the first embodiment;

FIG. 3A is a diagram showing an operation of a virtual viewpoint in the first embodiment;

FIG. 3B is a diagram showing an example of a virtual viewpoint image in the first embodiment;

FIG. 3C is a diagram showing an example of a virtual viewpoint image in the first embodiment;

FIG. 3D is a diagram showing an example of a warning display that is displayed on a virtual viewpoint image in an overlapping manner in the first embodiment;

FIG. 4 is a flowchart implemented by the information processing apparatus in the first embodiment;

FIG. 5 is a diagram showing a method of calculating a degree of similarity between virtual viewpoints in the first embodiment;

FIG. 6 is a configuration diagram of an information processing apparatus in a second embodiment;

FIG. 7 is a diagram showing an operation of a virtual viewpoint in the second embodiment;

FIG. 8 is a flowchart implemented by the information processing apparatus in the second embodiment;

FIG. 9A is a diagram showing restrictions on another virtual viewpoint in the second embodiment; and

FIG. 9B is a diagram showing restrictions on another virtual viewpoint in the second embodiment.

### DESCRIPTION OF THE EMBODIMENTS

In the following, preferred embodiments of the present disclosure are explained in detail based the attached drawings.

### First Embodiment

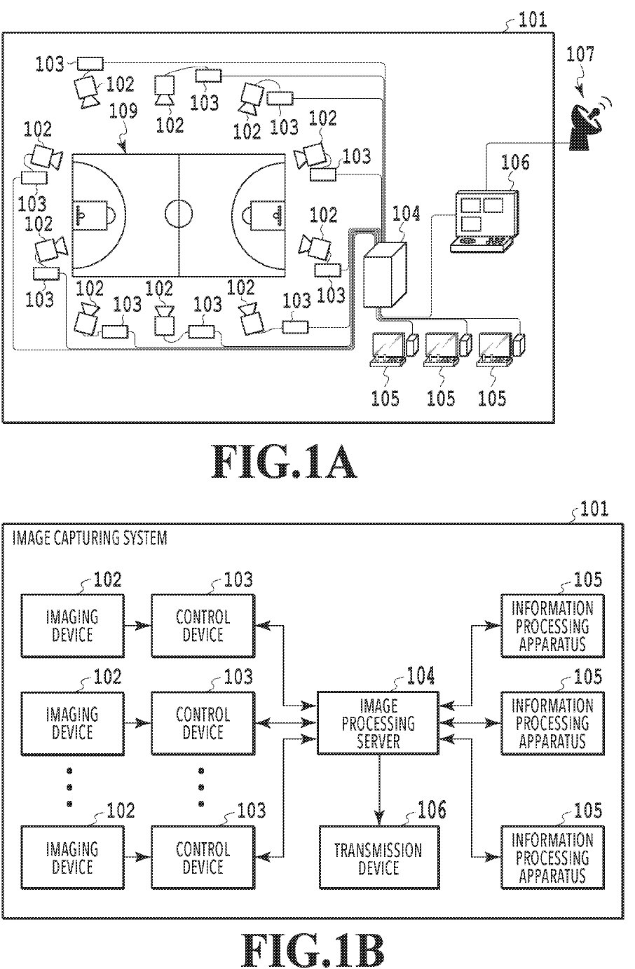

In the following, with reference to FIG. 1A to FIG. 6, an imaging device according to the first embodiment of the present disclosure is explained.

### General Image of Image Processing System

FIG. 1A is a schematic diagram showing an example of an image processing system 101 to which the present disclosure is applied and FIG. 1B is a block diagram showing the configuration of the image processing system 101.

The image processing system 101 includes a plurality of imaging devices 102, a plurality of control devices 103 to each of which each of the plurality of the imaging devices 102 is connected, an image processing server 104, and a plurality of information processing apparatuses 105. The plurality of the imaging devices 102 is arranged so as to surround an image capturing-target image capturing range 109 and the control device 103 connected to each imaging device 102 performs image processing, which is preprocessing, for a captured image obtained by each imaging device 102. The captured image processed by the control device 103 is aggregated in the image processing server 104 and the image processing server 104 generates a virtual viewpoint image representing an appearance from a virtual viewpoint operated by the information processing apparatus 105. A user performs the operation for the position and orientation of the virtual viewpoint with the information processing apparatus 105 while checking the virtual viewpoint image generated by the image processing server 104.

The image processing server 104 outputs a plurality of virtual viewpoint images corresponding to the virtual viewpoint operated by each information processing apparatus 105 to a transmission device 106 having functions as a video mixer, video switcher and the like. The transmission device 106 comprises a display unit configured to display a plurality of received virtual viewpoint images at the same time and a user who performs direction different from that of the operator of the information processing apparatus 105 selects and outputs one or more virtual viewpoint images from among the plurality of the displayed virtual viewpoint images. It is possible for the transmission device 106 to, in a case where a plurality of virtual viewpoint images is selected, edit them into one image by combining them, edit superimposed subtitles, and so on. Further, it may also be possible to connect an imaging device different from the imaging device 102 to the image processing server 104 or the transmission device 106 and enable the transmission device 106 to similarly select the captured image obtained from the imaging device as in the case of the virtual viewpoint image. The transmission device 106 sequentially transmits the selected virtual viewpoint images or the image obtained by editing them to an external transmitter 107.

The image processing system 101 shown in FIG. 1A has a star configuration in which each control device 103 to which each of the plurality of the imaging devices 102 is connected is connected to the image processing server 104, but the configuration is not limited to this. A configuration may be accepted in which the control devices 103 are connected in a daisy chain and one of the control devices 103 is connected to the image processing server 104. Further, in FIG. 1A, the ten imaging devices 102 are arranged, but the number of imaging devices may be any number and the number of imaging devices is not limited. Further, the control device 103 may be mounted inside the imaging device 102 as an image processing unit, or a configuration may be accepted in which the image processing server 104 performs the image processing, which is preprocessing, of the control device 103. Further, in FIG. 1A and FIG. 1B, the three information processing apparatuses 105 are provided, but the number may be any number larger than or equal to two.

### Configuration and Function of Information Processing Apparatus

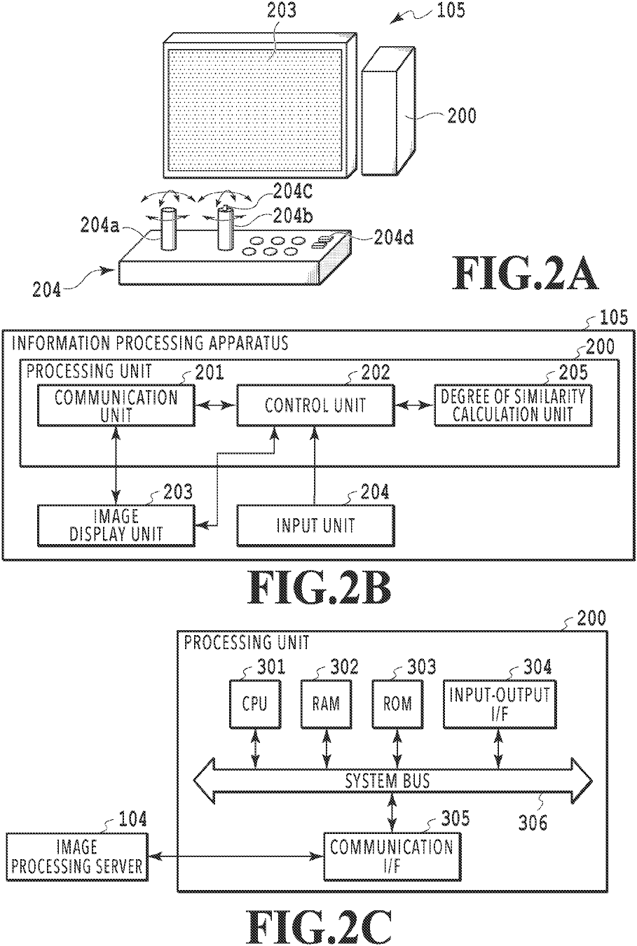

FIG. 2A to FIG. 2C are each a diagram showing the information processing apparatus 105 and FIG. 2A is a schematic diagram showing an outer appearance of the information processing apparatus 105, FIG. 2B is block diagram showing the function configuration of the information processing apparatus 105, and FIG. 2C is a block diagram showing the hardware configuration of the information processing apparatus 105.

As shown in FIG. 2A, the information processing apparatus 105 includes a processing unit 200, an image display unit 203, and an input unit 204. It is possible for the image display unit 203 to display an image including a virtual viewpoint image. The input unit 204 has sticks 204a, 204b and a button group 204d and an operator changes virtual viewpoint parameters by operating the sticks 204a, 204b and the button group 204d. The virtual viewpoint parameters include a parameter designating at least one of the position, orientation, zoom, and time of a virtual viewpoint. The position of a virtual viewpoint is designated by three-dimensional coordinates in an orthogonal coordinate system including three axes of X-axis, Y-axis, and Z-axis with the position determined in advance in the virtual viewpoint parameters being taken to be the origin. The orientation of a virtual viewpoint is designated by rotation angles of three axes of pan, tilt, and roll in the virtual viewpoint parameters. The zoom of a virtual viewpoint is designated by the scalar amount, for example, such as the focal length, in the virtual viewpoint parameter. The virtual viewpoint parameters may include a parameter that specifies another element and may not include all the above-described parameters.

Each of the sticks 204a, 204b has an operation axis of the degree of freedom of three and it is possible to operate translation for the X-, Y-, and Z-axes of a virtual viewpoint with the stick 204a and the rotation angles of pan, tilt, and roll of a virtual viewpoint with the stick 204b. Further, on the top of the stick 204b, a toggle-type zoom switch 204c is arranged and by tilting the zoom switch 204c toward the plus side or the minus side, it is possible to change the focal length of a virtual viewpoint within a focal length range determined in advance.

FIG. 2B is a block diagram showing the function configuration of the information processing apparatus 105. The information processing apparatus 105 has a communication unit 201, a control unit 202, and a degree of similarity calculation unit 205, which are included in the processing unit 200, the image display unit 203, and the input unit 204. The information processing apparatus 105 is connected to the image processing server 104 via the communication unit 201.

The communication unit 201 is connected to the control unit 202 within the processing unit 200 and sequentially transmits virtual viewpoint parameters generated by the control unit 202 to the image processing server 104 and receives data including a virtual viewpoint image from the image processing server 104. In the data including a virtual viewpoint image, which the communication unit 201 receives from the image processing server 104, virtual viewpoint parameters generated by another information processing apparatus 105, and the like are included and the communication unit 201 obtains the image and the parameters.

The input unit 204 transmits the amount of operation of the virtual viewpoint, which an operator inputs by operating the sticks 204a, 204b, and the button group 204d of the input unit 204, to the control unit 202.

The control unit 202 updates the virtual viewpoint parameters of the virtual viewpoint that the information processing apparatus 105 to which the control unit 202 belongs (in the following, “its own apparatus”) operates based on the amount of change of the virtual viewpoint parameters obtained from the input unit 204. Further, the control unit 202 is connected to the image display unit 203 and causes the image display unit 203 to display the virtual viewpoint image, the information relating to the virtual viewpoint, and the like, received by the communication unit 201. Due to this, it is made possible for an operator to operate the virtual viewpoint by using the input unit 204 while watching the virtual viewpoint image and the information relating to the virtual viewpoint, such as the virtual viewpoint parameters and the virtual viewpoint path, which are displayed on the image display unit 203.

The degree of similarity calculation unit 205 is connected to the control unit 202 and calculates the degree of similarity between the virtual viewpoint parameters of the virtual viewpoint that its own apparatus operates and the virtual viewpoint parameters of the virtual viewpoint that is operated by another information processing apparatus 105 (another apparatus) and performs similarity determination of the virtual viewpoint in accordance with the degree of similarity. The degree of similarity calculation unit 205 transmits the determination results of the similar virtual viewpoints to the control unit 202 and the control unit 202 switches the display of the image display unit 203 to another in accordance with the determination results of the similar virtual viewpoints. Details of the degree of similarity calculation processing and the image switching processing of the image display unit 203 will be described later. In the present embodiment, the configuration is such that the parameter obtaining in the degree of similarity calculation unit 205 is performed from the control unit 202, but it may also be possible to obtain the virtual viewpoint parameters of the virtual viewpoint that is operated by another apparatus directly from the communication unit 201.

Next, FIG. 2C is a block diagram showing the hardware configuration of the processing unit 200 of the information processing apparatus 105.

A CPU 301 is a processor that controls each constituent part of the processing unit 200 in an unified manner by executing programs stored in a ROM 303 using a RAM 302 as a work memory. Due to this, the CPU 301 functions as each part of the processing unit 200 in FIG. 2B. The RAM 302 temporarily stores computer programs read from the RAM 303, results of the calculation on the way, data supplied from the outside via a communication I/F 305, and the like. The ROM 303 retains computer programs and data that do not need to be changed. An input/output I/F 304 performs input and output of various kinds of data with a plurality of controllers for controlling the virtual viewpoint and the display device. The communication I/F 305 has a communication unit, such as Ethernet and USB, and performs communication with the image processing server 104. A bus 306 connects each constituent part of the processing unit 200 and transmits information.

### Degree of Similarity Calculation and Display Switch

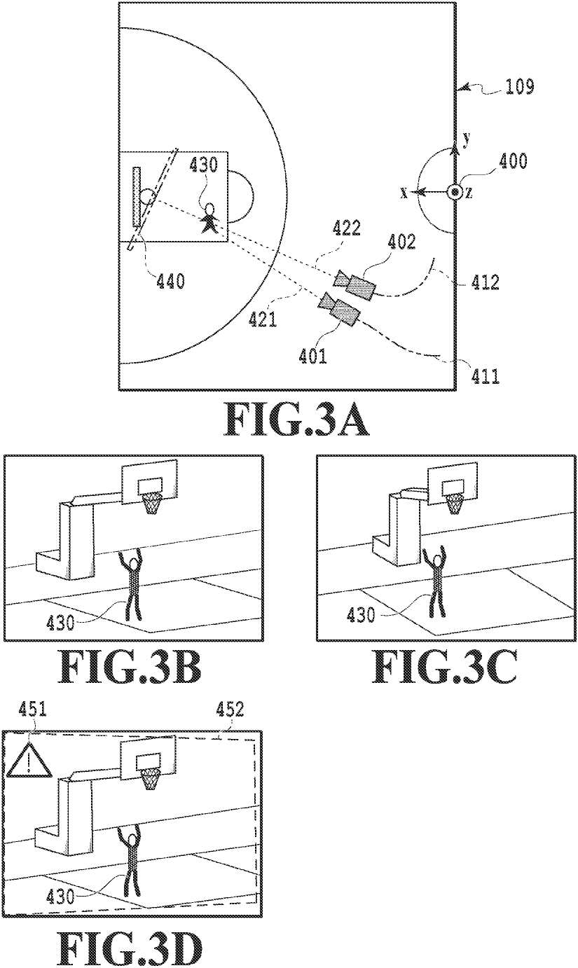

FIG. 3A to FIG. 3D are diagrams explaining a plurality of virtual viewpoints and the degree of similarity of the virtual viewpoint parameters thereof and FIG. 3A specifically shows the virtual viewpoint parameters including the position and orientation of a virtual viewpoint within a court, which is the image capturing range 109. In FIG. 3A, two virtual viewpoints 401, 402 having different virtual viewpoint parameters exist and from each virtual viewpoint, an area including an object 430 is captured. Each of 411, 412 indicated by one-dot chain lines indicates the virtual viewpoint path, which is the locus of each of the virtual viewpoints 401, 402. Further, each of 421, 422 indicated by dotted-lines indicates the line-of-sight direction of each of the virtual viewpoints 401, 402. Here, the operation of the information processing apparatus 105 that operates the virtual viewpoint 401 is described mainly.

As shown in FIG. 3A, the position of the virtual viewpoint 401 and the position of the virtual viewpoint 402 are similar to each other as a result of movement along the virtual viewpoint paths 411, 412. At this time, the virtual viewpoint image (FIG. 3B) representing the appearance from the virtual viewpoint 401 and the virtual viewpoint image (FIG. 3C) representing the appearance from the virtual viewpoint 402 are similar to each other. After this, in a case where one of operators who operate the virtual viewpoints 401, 402 notices the existence of the other virtual viewpoint that is similar and operates the virtual viewpoint so that the difference in the virtual viewpoint parameters becomes large, the degree of similarity between the two virtual viewpoints 401, 402 becomes low. However, in a case where neither of the operators of the virtual viewpoints 401, 402 notices the existence of the other virtual viewpoint that is similar and each continues the operation, it may happen sometimes that the virtual viewpoint images of the two virtual viewpoints 401, 402 continue to be similar.

Consequently, in the present embodiment, the degree of similarity calculation unit 205 calculates the degree of similarity between the virtual viewpoint parameters of the virtual viewpoint operated by its own apparatus and the virtual viewpoint parameters of the other virtual viewpoint and in a case where it is determined that the degree of similarity satisfies a similarity condition determined in advance, the control unit 202 causes the display of the image display unit 203 to be changed.

FIG. 3D shows the display of the image display unit 203 in a case where the information processing apparatus 105 that operates the virtual viewpoint 401 determines that there exists another virtual viewpoint whose degree of similarity is high. The image in FIG. 3D displays a warning display 451 in an overlapping manner on the image in FIG. 3B, which gives a notification that another virtual viewpoint whose virtual viewpoint parameters are similar exists. Due to this, it is possible for an operator to easily recognize that the virtual viewpoint operated by the operator him/herself is similar to another virtual viewpoint.

Further, the image in FIG. 3D displays an image capturing frame 452 of the virtual viewpoint 402 as an overlay on the virtual viewpoint image in FIG. 3B. The image capturing frame 452 is a frame virtually indicating the range captured from the virtual viewpoint 402 and displays the outer fame of the image capturing viewing angle of the virtual viewpoint 402 shown in FIG. 3A by projecting it on the virtual viewpoint image representing the appearance from the virtual viewpoint 401. It is possible for the operator to check the image capturing frame 452 of the other similar virtual viewpoint 402 on the virtual viewpoint image representing the appearance from the virtual viewpoint 401 operated by the operator him/herself. Due to this, it is made easier for the operator to estimate the position and image capturing area of the other similar virtual viewpoint, and therefore, it is made easier for the operator to recognize how to move the virtual viewpoint 401 operated by the operator him/herself in order to reduce the degree of similarity to the virtual viewpoint 402.

The displays for notifying the operator of the existence of another virtual viewpoint, such as the warning display 451 and the image capturing frame 452, are generated in the control unit 202. The image capturing frame 452 is generated from the virtual viewpoint parameters of the virtual viewpoint operated by the other apparatus, which are received by the communication unit 201.

Next, the degree of similarity calculation processing by the degree of similarity calculation unit 205 is described. The degree of similarity calculation unit 205 receives the virtual viewpoint parameters of the virtual viewpoint operated by its own apparatus and the virtual viewpoint parameters of another virtual viewpoint from the control unit 202 and compares the virtual viewpoint parameters between the virtual viewpoint operated by its own apparatus and another virtual viewpoint. In the present embodiment, the virtual viewpoint parameters retain information on the position, orientation, and focal length as in formula 1.

$$\left({x}_{n} , {y}_{n} , {z}_{n} , {p}_{n} , {t}_{n} , {r}_{n} , {f}_{n}\right) \qquad \text{(formula 1)}$$

Here, xₙ, yₙ, and zₙ each represent the position coordinate of the X-axis, the Y-axis, and the Z-axis in a three-dimensional coordinate system, pₙ, tₙ, and rₙ each represent the angle around the X-axis, the Y-axis, and the Z-axis, and fₙ represents the focal length and n attached to the bottom right of each character represents the number of the numbered virtual viewpoint. As shown in FIG. 3A, in the three-dimensional coordinate system, the X-axis and the Y-axis are taken in the horizontal direction on the paper surface from an origin 400 and the Z-axis is taken in the direction vertical to the paper surface for the image capturing range 109.

Here, in a case where the calculation of the degree of similarity between the virtual viewpoint 401 and the virtual viewpoint 402 is taken as an example, first, the positions (xₙ, yₙ, zₙ) of the virtual viewpoints are compared. As shown in formula 2, a degree of positional similarity dL is calculated, which is the inverse of the difference in position between the virtual viewpoint 401 and the virtual viewpoint 402.

$$\text{dL =} 1 / \left\{\text{a1} {\left({\text{x}}_{402} {\text{- x}}_{401}\right)}^{2} + \text{a} \text{2} {\left({\text{y}}_{402} {\text{- y}}_{401}\right)}^{2} + \text{a3} {\left({\text{z}}_{402} {\text{- z}}_{401}\right)}^{2}\right\} \qquad \text{(formula 2)}$$

Here, a1, a2, and a3 in formula 2 are each a weighting coefficient and a numerical value from 0 to 1 is set in advance for each. For example, in a case where importance is given to the distance on the XY-plane in the image capturing range 109 shown in FIG. 3A, a1 and a2 are set to 1 and a3 is set to a value smaller than 1. As an example of another weighting, it may also be possible to set the weighting coefficients a1, a2, and a3 in accordance with the focal length. Then, whether or not the degree of positional similarity dL is higher than a threshold value T1 determined in advance is determined. In a case where the degree of positional similarity dL ≤ the threshold value T1, it is determined that the virtual viewpoint parameters of virtual viewpoints are not similar. On the other hand, in a case where the degree of positional similarity dL is higher than the threshold value T1, that is, in a case where the degree of positional similarity dL > the threshold value T1, it is determined that the positions of the virtual viewpoints are similar and the orientations (pₙ, tₙ, rₙ) of the virtual viewpoints are compared. As shown in formula 3, a degree of orientational similarity dA is calculated, which is the inverse of the difference between the rotation angles indicating the orientations of the virtual viewpoint 401 and the virtual viewpoint 402.

$$\text{dA} = 1 / \left\{b 1 {\left({p}_{402} \text{-} {p}_{401}\right)}^{2} + b 2 {\left({t}_{402} \text{-} {t}_{401}\right)}^{2} + b 3 {\left({r}_{402} \text{-} {r}_{401}\right)}^{2}\right\} \qquad \text{(formula 3)}$$

Here, b1, b2, and b3 in formula 3 are each a weighting coefficient and a numerical value from 0 to 1 is set in advance for each. For example, in a case where virtual viewpoints are at the same position, on a condition that the rotation angles of pan and tilt are different, the difference between images that are obtained is large, but even the rotation angles of roll are different, it is considered that the difference is small, and therefore, b1 and b2 are set to 1 and b3 is set to a value smaller than 1. Then, whether or not the degree of orientational similarity dA is higher than a threshold value Ta determined in advance is determined. In a case where the degree of orientational similarity dA ≤ the threshold value Ta, it is determined that the virtual viewpoint parameters of virtual viewpoints are not similar. On the other hand, in a case where the degree of orientational similarity dA is higher than the threshold value Ta, that is, in a case where the degree of orientational similarity dA > the threshold value Ta, the positions and orientations of the virtual viewpoint 401 and the virtual viewpoint 402 are similar, and therefore, it is determined that the degree of similarity of between the virtual viewpoint parameters is high.

In the present embodiment, the degrees of similarity are found as the inverse of the difference in distance relating to the position and as the inverse of the difference in rotation angle relating to the orientation and then similarity or non-similarity is determined by providing the threshold value for each degree of similarity, but it may also be possible to determine similarity or non-similarity by defining the degree of similarity as follows. In formula 4, a combined degree of similarity Nr is calculated, which is a weighted sum of the degree of positional similarity dL and the degree of orientational similarity dA found by formula 2 and formula 3.

$$\text{Nr} = d L ⋅ k 1 + d A ⋅ k 2 \qquad \text{(formula 4)}$$

Here, k1 is a weighting coefficient of the degree of positional similarity and k2 is a weighting coefficient of the degree of orientational similarity . Further, while the degree of positional similarity dL is calculated from the distance, the degree of orientational similarity dA is calculated from the angle [rad], and therefore, k2 also serves as a conversion coefficient for enabling the comparison therebetween. It may also be possible to determine whether or not the combined degree of similarity Nr is higher than a threshold value Tn determined in advance and determine similarity or non-similarity based on the determination results. Further, it may also be possible to further find and add the value of the difference in focal length at the time of finding the combined degree of similarity Nr. Furthermore, it may also be possible to find the difference for each element of the virtual viewpoint parameters expressed in formula 1, provide a threshold value for each element, and determine similarity or non-similarity in accordance with whether or not the differences of all the elements are higher than a threshold value. The method of calculating the degree of similarity is not limited to those and it may also be possible to perform calculation by defining the degree of positional similarity of the virtual viewpoint parameters by another method.

### Flow

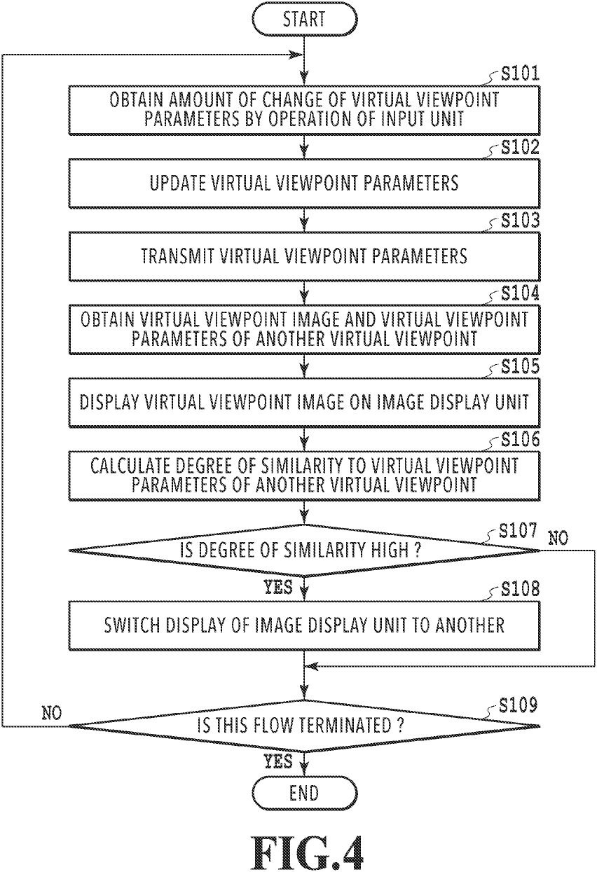

FIG. 4 shows a flowchart explaining the processing in the information processing apparatuses 105 according to the present embodiment.

At S101, the control unit 202 obtains the amount of change of the virtual viewpoint parameters from the amount of operation input by an operator operating the input unit 204.

At S102, the control unit 202 updates the virtual viewpoint parameters of the virtual viewpoint operated by its own apparatus in accordance with the obtained amount of operation of the virtual viewpoint.

At S103, the control unit 202 transmits the updated virtual viewpoint parameters to the image processing sever 104 via the communication unit 201.

At S104, the control unit 202 obtains the virtual viewpoint image generated based on the virtual viewpoint parameters transmitted at S103 and the virtual viewpoint parameters of another virtual viewpoint from the image processing server 104 via the communication unit 201.

At S105, the control unit 202 causes the image display unit 203 to display the obtained virtual viewpoint image.

At S106, the degree of similarity calculation unit 205 obtains the virtual viewpoint parameters from the control unit 202 and calculates the degree of similarity between the virtual viewpoint parameters of the virtual viewpoint operated by its own apparatus and the virtual viewpoint parameters of the other virtual viewpoint.

At S107, the degree of similarity calculation unit 205 determines whether or not the degree of similarity is higher than a threshold value determined in advance. In a case where the degree of similarity calculation unit 205 determines that the degree of similarity is higher than the threshold value, the processing advances to S108 and in a case where the degree of similarity calculation unit 205 determines that the degree of similarity is lower than or equal to the threshold value, the processing advances to S109.

At S108, the control unit 202 displays the warning display 451 and the image capturing frame 452 of the similar virtual viewpoint on the virtual viewpoint image in an overlapping manner as shown in FIG. 4D based on the determination results of the degree of similarity calculation unit 205.

At S109, the control unit 202 determines whether instructions to terminate the work of the information processing apparatus 105 are given. In a case where the instructions to terminate the work are not given, the processing returns to S101 and this flow is repeated and in a case where the instructions to terminate the work are given, this flow is terminated.

As explained above, in the image processing system that provides a virtual viewpoint image of the present embodiment, in a case where each of different operators generates a plurality of virtual viewpoint images by operating a plurality of virtual viewpoints, it is possible to make it easy to avoid similar virtual viewpoint images from being generated.

### Calculation of Degree of Similarity Also Including Predetermined Period of Time

The degree of similarity calculation explained so far is performed by comparing the virtual viewpoint parameters at a certain time, but it may also be possible to determine whether the degree of similarity is high by comparing the virtual viewpoint parameters in a predetermined period of time.

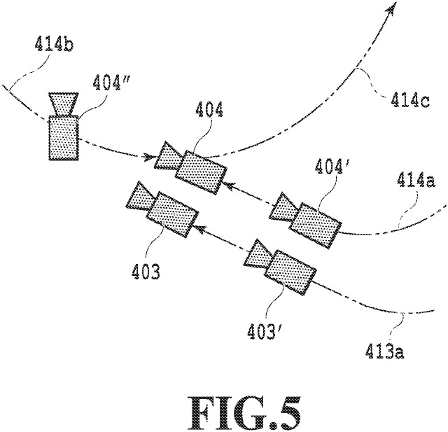

FIG. 5 is a schematic diagram showing positions, orientations and virtual viewpoint paths, which are virtual viewpoint loci, of two virtual viewpoints. Virtual viewpoints 403 and 404 shown in FIG. 5 indicate positions of the two virtual viewpoints at a time t (i). The virtual viewpoint 403 moves on a virtual viewpoint path 413a of a one-dot chain line and a virtual viewpoint 403′ indicates the position of the virtual viewpoint 403 at a time t (i-1) a bit earlier than the time t (i). Similarly, the virtual viewpoint 404 moves on a virtual viewpoint path 414a of a one-dot chain line and a virtual viewpoint 404′ indicates the position of the virtual viewpoint 404 at the time t (i-1) a bit earlier than the time t (i). It is assumed that the positions and orientations of the virtual viewpoints 403 and 404 at the time t (i) and the virtual viewpoints 403′ and 404′ at the time t (i-1) are close, and therefore, the virtual viewpoint parameters thereof are determined to be similar.

On the other hand, a virtual viewpoint path 414b indicates a virtual viewpoint path of the virtual viewpoint 404, which is different from the virtual viewpoint path 414a, and a virtual viewpoint 404″ indicates the position at the time t (i-1) in a case where the virtual viewpoint 404 moves on the virtual viewpoint path 414b. In a case the virtual viewpoint 404 moves on the virtual viewpoint path 414b and a virtual viewpoint path 414c, the virtual viewpoint parameters of the virtual viewpoints 403 and 404 are determined to be similar at the time t (i), but there is a case where the virtual viewpoint parameters of the previous virtual viewpoints and the subsequent virtual viewpoints are not determined to be similar.

Consequently, in a case where the degree of similarity of the virtual viewpoint parameters of each virtual viewpoint is compared with that of the virtual viewpoint parameters of another virtual viewpoint by the degree of similarity calculation unit 205, it may also be possible to calculate the degree of similarity of the virtual viewpoint parameters within a predetermined period of time and determine whether the degree of similarity is high. For example, in a case where it is determined that the degree of similarity of the virtual viewpoint parameters between the virtual viewpoint operated by its own apparatus and another virtual viewpoint is high at the time t (i), processing is performed as follows. First, also for the virtual viewpoint parameters in each frame during the period of time from a time (i - j) determined in advance to the time (i - 1), the degree of positional similarity and the degree of orientational similarity are calculated by formula 2 and formula 3 described above. Then, only in a case where the degree of similarity is higher than a threshold value in all the frames during the period of time, it is determined that the virtual viewpoint parameters of the two virtual viewpoints are similar and the display of the image display unit 203 is switched to another. It may also be possible to determine whether or not there is similarity by finding the sum of the degree of similarity in each frame and determine similarity only in a case where the sum of the degree of similarity is higher than a threshold value for the sum of the degree of similarity.

It is possible to apply the present embodiment to a scheme in which the transmission device 106 selects an arbitrary image from among a plurality of virtual viewpoint images whose virtual viewpoint is different from one another and transmits the image on a broadcast radio wave from the transmitter 107, or a scheme in which the transmitter 107 distributes an image via a network, such as the internet.

It may also be possible for the transmission device 106 to convert all the virtual viewpoint images into images with a small amount of data whose bitrate is low and transmit them to a network instead of selecting one from among a plurality of virtual viewpoint images and transmitting it. A viewer selects one desired virtual viewpoint image from among the received plurality of virtual viewpoint images and requests the transmission device 106 side to enable reception of the selected one virtual viewpoint image in a state where the bitrate is retained. By using the scheme such as this, it is possible for each viewer to enjoy a virtual viewpoint image desired by him/herself. In the scheme such as this also, a reduction in the number of variations of selectable virtual viewpoint images will hurt the feeling of satisfaction of a viewer, and therefore, it is necessary to prevent a reduction in the number of variations of virtual viewpoint images.

In a case where similarity to the virtual viewpoint operated by another apparatus is determined, it may also be possible to give a voice notification to an operator as well as switching the display of the image display unit 230 to another. Alternatively, it may also be possible only to give a voice notification without changing the image display 217. Further, in the present embodiment, the degree of similarity calculation unit 205 is provided within the information processing apparatus 105, but it may also be possible to provide the degree of similarity calculation unit 205 on the side of the image processing server 104. In a case where the degree of similarity calculation unit 205 is located within the image processing server 104, the degree of similarity is calculated for the updated values of the virtual viewpoint parameters that are sent from each information processing apparatus 105 to determine whether or not there is similarity and the determination results are transmitted to the information processing apparatus 105.

### Second Embodiment

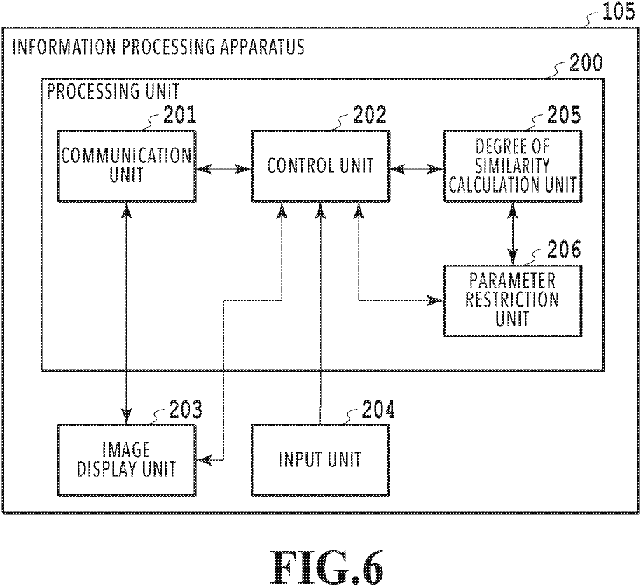

Next, by using FIG. 6 to FIG. 8, an image processing system in the second embodiment is described.

The configuration of the image processing system in the second embodiment is the same as the configuration shown in FIG. 1A and FIG. 1B of the first embodiment, and therefore, explanation is omitted.

FIG. 6 is a block diagram showing the function block of the information processing apparatus 105 in the second embodiment and to the same unit having the same function as that in FIG. 2B, the same number is appended. The difference from FIG. 2B is that a parameter restriction unit 206 is provided. The parameter restriction unit 206 imposes predetermined restrictions on the control of the virtual viewpoint parameters in accordance with results of the degree of similarity calculation unit 205.

### Explanation of Restrictions

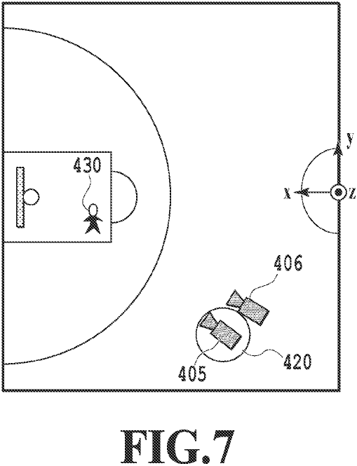

Next, by using FIG. 7, restrictions on the virtual viewpoint parameters are explained. In the second embodiment, a plurality of the information processing apparatuses 105 and a plurality of virtual viewpoints operated by them exist and to each virtual viewpoint, priority is given in a predetermined order. This priority is transmitted in advance to all the information processing apparatuses 105 via the image processing server 104 from, for example, the transmission device 106 and each information processing apparatus 105 obtains the priority.

FIG. 7 shows an example in which two virtual viewpoints 405 and 406 exist, which are determined to be similar. At this time, the information processing apparatus 105 that operates the virtual viewpoint 405 compares the priority of its own with the priority of the virtual viewpoint 406 determined to be similar to the virtual viewpoint 405. In a case where the priority of the virtual viewpoint 405 operated by its own apparatus is lower than the priority of the virtual viewpoint 406 operated by the other apparatus, the display of the image display unit 203 is switched to another and a warning display is produced and at the same time, the control of the virtual viewpoint parameters is restricted by the parameter restriction unit 206. Specifically, the virtual viewpoint parameters of the virtual viewpoint whose priority is lower are restricted so that it is not possible for the virtual viewpoint whose priority is lower to be located within a restriction range 420, which is a circle with a radius R, whose center is taken to be the position of the virtual viewpoint whose priority is higher. On the other hand, in a case where the priority of the virtual viewpoint operated by its own apparatus is higher than the priority of the virtual viewpoint operated by the other apparatus, a warning display is not produced on the image display unit 203 or the virtual viewpoint parameters are not restricted. For example, the highest priority is appended to the virtual viewpoint of the virtual viewpoint image that is transmitted mainly by the transmission device 106 and provided to a viewer and priority is appended to each of other virtual viewpoints in order. In this case, it is possible for the operator of the main virtual viewpoint whose priority is high to continue the operation without the warning display or restrictions on the operation of the virtual viewpoint. On the other hand, the operator of the virtual viewpoint that is not main and whose priority is low performs the operation so that the virtual viewpoint parameters are not similar to those of the main virtual viewpoint. It may also be possible to have priority as one of the virtual viewpoint parameters or retain as separate tag information.

### Flow

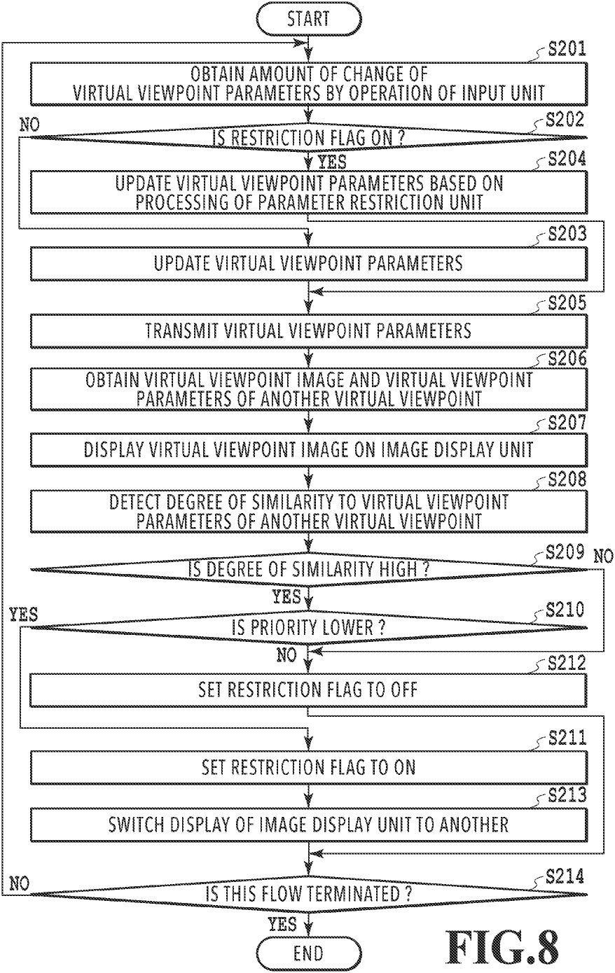

Next, by using FIG. 8, a flow of the information processing apparatus 105 in the second embodiment is described. FIG. 8 is a flowchart representing the operation of the information processing apparatus 105 according to the second embodiment. In the flow of the second embodiment, in a case where it is determined that the virtual viewpoint parameters of the virtual viewpoint operated by its own apparatus are similar to the virtual viewpoint parameters of the virtual viewpoint operated by another apparatus, the priority is compared with the priority of the similar virtual viewpoint. In a case where the priority of the virtual viewpoint operated by its own apparatus is lower than that of the virtual viewpoint operated by another apparatus, a restriction flag of the virtual viewpoint parameters of the virtual viewpoint operated by its own apparatus is set to ON. The information processing apparatus 105 performs control so that restrictions are imposed on the updating of the virtual viewpoint parameters in a case where the restriction flag of the virtual viewpoint parameters is in the ON state. It is assumed that the restriction flag is in the OFF state at the time of the start of the flow.

At S201, the control unit 202 obtains the amount of change of the virtual viewpoint parameters from the amount of operation that is input by an operator operating the input unit 204.

At S202, the control unit 202 determines whether the restriction flag of the virtual viewpoint parameters is ON. In a case where the restriction flag is OFF, the processing advances to S203 and in a case where the restriction flag is ON, the processing advances to S204.

At S203, the control unit 202 updates the virtual viewpoint parameters of the virtual viewpoint operated by its own apparatus based on the amount of change of the virtual viewpoint parameters, which is obtained at S201.

At S204, the control unit 202 updates the virtual viewpoint parameters of the virtual viewpoint operated by its own apparatus by imposing restrictions based on the processing of the parameter restriction unit 206 on the amount of change of the virtual viewpoint parameters, which is obtained at S201. For example, it is assumed that in a case where the virtual viewpoint parameters are updated based on the amount of change of the virtual viewpoint parameters, which is obtained at S201, the virtual viewpoint 406 is included in the restriction range 420 shown in FIG. 7. In this case, the virtual viewpoint parameters are updated so that the virtual viewpoint 406 is outside the restriction range 420. Alternatively, the change of the virtual viewpoint parameters may be restricted so that the virtual viewpoint remains at the same position and in the same orientation and the values of the previous virtual viewpoint parameters may be used as they are. In addition, in accordance with a predetermined restriction method, the virtual viewpoint parameters of the virtual viewpoint operated by its own apparatus are updated based on the parameter restriction unit 206.

At S205, the control unit 202 transmits the virtual viewpoint parameters updated at S204 from the communication unit 201 to the image processing server 104.

At S206, the control unit 202 obtains the virtual viewpoint parameters of the other virtual viewpoint as well as obtaining the virtual viewpoint image generated based on the virtual viewpoint parameters transmitted at S205 from the side of the image processing server 104.

At S207, the control unit 202 displays the virtual viewpoint image obtained at S206 on the image display unit 203.

At S208, the control unit 202 calculates the degree of similarity of the virtual viewpoint parameters between the virtual viewpoint operated by its own apparatus and the virtual viewpoint operated by the other apparatus with the degree of similarity calculation unit 205 based on the virtual viewpoint parameters of the virtual viewpoint operated by the other apparatus, which are obtained at S206.

At S209, the control unit 202 determines whether or not the degree of similarity calculated with the degree of similarity calculation unit 205 is higher than a threshold value. In a case where it is determined that the degree of similarity is higher than the degree of similarity and the virtual viewpoint parameters are similar, the processing advances to S210 and in a case where it is determined that the degree of similarity is lower than or equal to the threshold value and the virtual viewpoint parameters are not similar, the processing advances to S212.

At S210, the control unit 202 determines whether or not the priority of the virtual viewpoint operated by its own apparatus is higher than the priority of the similar virtual viewpoint operated by the other apparatus by using the degree of similarity calculation unit 205. In a case where it is determined that the priority of the virtual viewpoint operated by its own apparatus is lower than the priority of the virtual viewpoint operated by the other apparatus, the processing advances to S211 and in a case where it is determined that the priority of the virtual viewpoint operated by its own apparatus is higher than the priority of the virtual viewpoint operated by the other apparatus, the processing advances to S212.

At S211, the control unit 202 sets the restriction flag of the virtual viewpoint parameters to ON.

At S212, the control unit 202 sets the restriction flag of the virtual viewpoint parameters to OFF.

At S213, the control unit 202 switches the display screen of the image display unit 203 to another and displays the warning display 451 in an overlapping manner on the virtual viewpoint image that is displayed at the time of an operator operating the virtual viewpoint as shown in FIG. 3D of the first embodiment.

At S214, the control unit 202 determines whether or not instructions to terminate the work of the information processing apparatus 105 are given. In a case where the instructions to terminate the work are not given, the processing returns to S201 and the flow is repeated and in a case the instructions to terminate the work are given, the flow is terminated.

As explained above, in the image processing system that provides a virtual viewpoint image of the second embodiment, priority is appended in advance to a plurality of virtual viewpoints and the priority is compared with that of a similar virtual viewpoint. Then, in a case where the priority of the virtual viewpoint operated by its own apparatus is lower than that of the virtual viewpoint operated by another apparatus, the warning display is displayed in an overlapping manner on the virtual viewpoint image that is viewed at the time of operation and at the same time, restrictions are imposed on the change of the virtual viewpoint parameters by the operation of the input unit 204. Due to this, in a case where a plurality of operators operates a plurality of virtual viewpoints separately, it is possible to prevent similar virtual viewpoint images from being generated.

In the present embodiment, the parameter restriction unit 206 imposes restrictions so that the virtual viewpoint that is restricted is prevented from moving into the restriction area within a predetermined distance from the virtual viewpoint whose priority is high, but another restriction method may be accepted. For example, it may also be possible to allow the virtual viewpoint whose priority is low to move into the restriction area but reduce the amount of change of the virtual viewpoint parameters for the amount of operation of the input unit 204 within the restriction area, thereby reducing the moving speed. For example, it may be possible to halve the amount of change of the virtual viewpoint parameters for the amount of operation of the input unit 204 within the restriction area compared to that outside the restriction area.

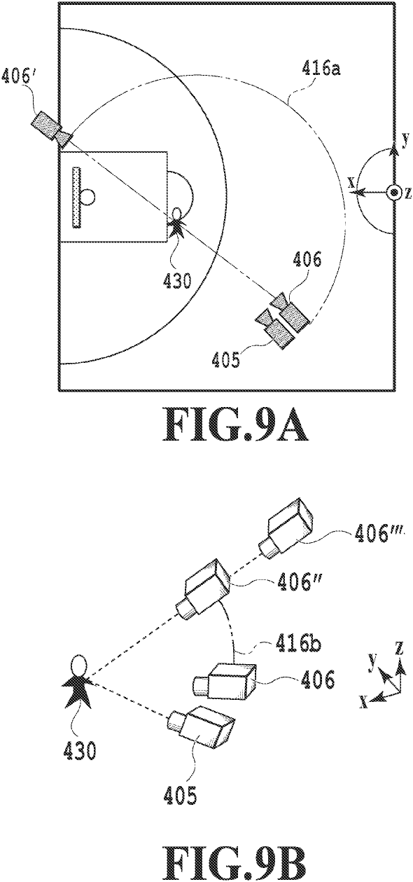

Further, it may also be possible for the parameter restriction unit 206 to forcibly move the virtual viewpoint by a moving method that is set in advance. FIG. 9A and FIG. 9B are each a schematic diagram showing a restriction method of the virtual viewpoint parameters of the parameter restriction unit 206. In FIG. 9A, the virtual viewpoints 405 and 406 similar to each other exist and it is assumed that the priority of the virtual viewpoint 405 is set higher than that of the virtual viewpoint 406. In this case, the virtual viewpoint 406 whose priority is lower is forcibly moved so that the degree of similarity between the virtual viewpoint parameters of the virtual viewpoint 406 and those of the virtual viewpoint 405 becomes significantly low. The state indicated by 406′ shown in FIG. 9A shows a state after the virtual viewpoint 406 is rotated by a predetermined angle of 180 degrees about the object 430 as a center, which is the gaze point of the virtual viewpoint 406. The virtual viewpoint 406 is forcibly moved up to the virtual viewpoint 406′ on a locus 416a on the XY-plane. While the virtual viewpoint is being forcibly moved, the virtual viewpoint parameters are restricted from being changed by operating the input unit 204.

By forcibly moving the virtual viewpoint 406 whose priority is lower of the virtual viewpoints 405 and 406 similar to each other as described above, it is possible to obtain a virtual viewpoint image different from that from the virtual viewpoint 405 and the number of variations of virtual viewpoint images selectable by the transmission device 106 increases. The predetermined angle is not limited to 180 degrees and an arbitrary angle, such as 45 degrees and 90 degrees, may be accepted.

Further, a case is considered where another virtual viewpoint exists on the periphery of the position to which the virtual viewpoint 406 is moved forcibly and a virtual viewpoint similar to the virtual viewpoint 406 exits even after movement. Consequently, at the time of forcibly moving the virtual viewpoint 406 on the circular arc with the gaze point of the virtual viewpoint 406 being taken as a center, in a case where a third virtual viewpoint other than the virtual viewpoint 405 exists in the vicinity of the circular arc, it may also be possible to move the virtual viewpoint 406 to the position whose distances to both the virtual viewpoint 405 and the third virtual viewpoint are the longest.

In addition to the above, as shown in FIG. 9B, it may also be possible to forcibly move the virtual viewpoint 406 in the Z-axis direction. In FIG. 9B, as in FIG. 9A, the two virtual viewpoints 405 and 406 similar to each other exist and the priority of the virtual viewpoint 405 is set higher than that of the virtual viewpoint 406. As shown in FIG. 9B, on the plane including the Z-axis and the virtual viewpoint 406, the virtual viewpoint 406 is rotated and moved by predetermined angles about the object 430 as a center, which is the gaze point of the virtual viewpoint 406, and moved to the position of a virtual viewpoint 406″ along a locus 416b. Further, it may also be possible to move the virtual viewpoint 406 from the virtual viewpoint 406″ to a virtual viewpoint 406‴ by moving the virtual viewpoint 406 in the opposite direction of the line-of-sight direction. By forcibly moving the virtual viewpoint 406 in the Z-axis direction as described above, it is possible to obtain a virtual viewpoint image viewed from a bird’s eye, which is different from that obtained from the virtual viewpoint 405. In the above description, the virtual viewpoint 406 is moved along the locus 416b and then moved in the opposite direction of the line-of-sight direction, but it may also be possible to move the virtual viewpoint 406 to the position of the virtual viewpoint 406‴ along the shortest path. Further, in place of moving the virtual viewpoint 406 in the opposite direction of the line-of-sight direction, it may also be possible to obtain the same effect by changing the focal length, which is one of the virtual viewpoint parameters, to the wide-angle focal length.

Further, in a case where the one virtual viewpoint is lower than that of another similar virtual viewpoints, it may also be possible to provide a delay period of time before imposing restrictions on the change of the virtual viewpoint parameters. For example, the warning display is displayed on the image display unit 203 of the information processing apparatuses 105 that operates the virtual viewpoint whose priority is lower of the virtual viewpoints similar to each other, but restrictions are not imposed on the virtual viewpoint parameters immediately. Then, a restriction cancel button is set as one of the buttons of the button group 204d of the input unit 204 and in a case where the cancel button is not pressed down within a predetermined time after the waring display is displayed, restrictions are imposed on the virtual viewpoint parameters. On the other hand, in a case where the cancel button is pressed down within the predetermined time, it may also be possible to perform control so that the mode is switched to a mode in which restrictions are not imposed on the virtual viewpoint parameters even though the degree of similarity to the virtual viewpoint is high.

Further, it may also be possible to prepare in advance two threshold values of the degree of similarity in the degree of similarity calculation unit 205 and first produce the warning display in a case where the calculated degree of similarity exceeds a first threshold value and then impose restrictions on the virtual viewpoint parameters in a case where the calculated degree of similarity exceeds a second threshold value after time elapses further.

In the present embodiment, the degree of similarity calculation unit 205 and the parameter restriction unit 206 are located within the information processing apparatuses 105, but one or both of the degree of similarity calculation unit 205 and the parameter restriction unit 206 may be located on the side of the image processing server 104. In a case where the degree of similarity calculation unit 205 is located within the image processing server 104, the degree of similarity is calculated for the updated values of the virtual viewpoint parameters, which are sent from each information processing apparatuses 105, and whether or not there is similarity is determined and the determination results are transmitted to the information processing apparatuses 105. Further, in a case where the parameter restriction unit 206 is located within the image processing server 104, it may also be possible to impose restrictions on the updated values of the virtual viewpoint parameters, which are sent from each information processing apparatuses 105 and generate a virtual viewpoint image based on the restricted updated values of the virtual viewpoint parameters.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

According to the present disclosure, it is possible to make it unlikely that similar virtual viewpoint images are generated at the time of generating a plurality of virtual viewpoint images based on a plurality of virtual viewpoints.

This application claims the benefit of Japanese Patent Application No. 2022-067856 filed Apr. 15, 2022, which is hereby incorporated by reference wherein in its entirety.

What is claimed is:

1. An information processing apparatus comprising:
one or more processors;
at least one memory coupled to the one or more processors storing instructions that, when executed by the one or more processors, cause the one or more processors to function as:
a parameter obtaining unit configured to obtain virtual viewpoint parameters specifying each virtual viewpoint of a plurality of virtual viewpoints; and
a notification unit configured to notify that a similar virtual viewpoint exists in a case where there are virtual viewpoint parameters of a second virtual viewpoint different from a first virtual viewpoint, which indicate a position and an orientation similar to at least a position and an orientation indicated by virtual viewpoint parameters of the first virtual viewpoint, among virtual viewpoint parameters of a plurality of virtual viewpoint parameters, which indicate a time identical to a time indicated by the virtual viewpoint parameter of the first virtual viewpoint among the plurality of virtual viewpoint parameters obtained by the parameter obtaining unit.

2. The information processing apparatus according to claim 1, further comprising:
a similarity determination unit configured to determine whether or not virtual viewpoint parameters of a first virtual viewpoint and virtual viewpoint parameters of a second virtual viewpoint different from the first virtual viewpoint are similar.

3. The information processing apparatus according to claim 1, wherein
the notification unit obtains determination results from an external apparatus including a similarity determination unit configured to determine whether or not virtual viewpoint parameters of a first virtual viewpoint and virtual viewpoint parameters of a second virtual viewpoint different from the first virtual viewpoint are similar.

4. The information processing apparatus according to claim 2, wherein
the similarity determination unit calculates a degree of similarity between the virtual viewpoint parameters of the first virtual viewpoint and the virtual viewpoint parameters of the second virtual viewpoint and determines that there is similarity in a case where the degree of similarity is higher than a threshold value determined in advance.

5. The information processing apparatus according to claim 4, wherein
the degree of similarity is higher than the threshold value in a case where the first virtual viewpoint is located within a distance determined in advance from the second virtual viewpoint.

6. The information processing apparatus according to claim 4, wherein
the similarity determination unit calculates the degree of similarity based on the virtual viewpoint parameters of the first virtual viewpoint and the virtual viewpoint parameters of the second virtual viewpoint within a period of time determined in advance.

7. The information processing apparatus according to claim 1, further comprising:
an image obtaining unit configured to transmit the virtual viewpoint parameters of the first virtual viewpoint to an image processing apparatus and receive, from the image processing apparatus, a first virtual viewpoint image generated based the virtual viewpoint parameters of the first virtual viewpoint and a plurality of captured images obtained from a plurality of imaging devices.

8. The information processing apparatus according to claim 7, wherein
the notification unit displays a notification in an overlapping manner on the first virtual viewpoint image obtained by the image obtaining unit.

9. The information processing apparatus according to claim 1, wherein
the notification unit displays an image capturing range of a second virtual viewpoint image based on the virtual viewpoint parameters of the second virtual viewpoint, which is generated based on the virtual viewpoint parameters of the second virtual viewpoint and a plurality of captured images obtained from a plurality of imaging devices.

10. An information processing apparatus comprising:
one or more processors;
at least one memory coupled to the one or more processors storing instructions that, when executed by the one or more processors, cause the one or more processors to function as:
a parameter obtaining unit configured to obtain virtual viewpoint parameters specifying each virtual viewpoint of a plurality of virtual viewpoints;
a reception unit configured to receive a change of virtual viewpoint parameters of a first virtual viewpoint among virtual viewpoint parameters of a plurality of virtual viewpoints obtained by the parameter obtaining unit; and
a restriction unit configured to restrict, in a case where there are virtual viewpoint parameters of a second virtual viewpoint different from the first virtual viewpoint, which indicate a position and an orientation similar to a position and an orientation indicated by the virtual viewpoint parameters of the first virtual viewpoint, among a plurality of virtual viewpoint parameters obtained by the parameter obtaining unit, the change of the virtual viewpoint parameters of the first virtual viewpoint received by the reception unit to a change that causes the virtual viewpoint parameters of the first virtual viewpoint to be no longer similar to the virtual viewpoint parameters of the second virtual viewpoint.

11. The information processing apparatus according to claim 10, further comprising:
a priority obtaining unit configured to obtain priority that is set to the plurality of virtual viewpoints, wherein
the restriction unit imposes restrictions on a change of the virtual viewpoint parameters of the first virtual viewpoint in a case where the virtual viewpoint parameters of the first virtual viewpoint and the virtual viewpoint parameters of a second virtual viewpoint different from the first virtual viewpoint are similar and priority of the first virtual viewpoint is lower than priority of the second virtual viewpoint.

12. The information processing apparatus according to claim 10, wherein
the restrictions on the change of the virtual viewpoint parameters of the first virtual viewpoint by the restriction unit are moving the first virtual viewpoint to a position determined in advance.

13. The information processing apparatus according to claim 12, wherein
the restrictions on the change of the virtual viewpoint parameters of the first virtual viewpoint by the restriction unit are rotating and moving the first virtual viewpoint by angles determined in advance about a gaze point of the first virtual viewpoint as a center.

14. The information processing apparatus according to claim 1, wherein
the parameter obtaining unit includes:
a reception unit configured to receive an input designating the virtual viewpoint parameters of the first virtual viewpoint; and
a generation unit configured to generate the virtual viewpoint parameters of the first virtual viewpoint based on the input received by the reception unit.

15. The information processing apparatus according to claim 1, wherein
the virtual viewpoint parameters include at least one of a position, orientation, zoom, and time of the virtual viewpoint.

16. An information processing method comprising:
obtaining virtual viewpoint parameters specifying each virtual viewpoint of a plurality of virtual viewpoints; and
notifying that a similar virtual viewpoint exists in a case where there are virtual viewpoint parameters of a second virtual viewpoint different from a first virtual viewpoint, which indicate a position and an orientation similar to at least a position and an orientation indicated by virtual viewpoint parameters of the first virtual viewpoint, among virtual viewpoint parameters of a plurality of virtual viewpoint parameters, which indicate a time identical to a time indicated by the virtual viewpoint parameter of the first virtual viewpoint among the plurality of virtual viewpoint parameters obtained.

17. An information processing method comprising:
obtaining virtual viewpoint parameters specifying each virtual viewpoint of a plurality of virtual viewpoints;
receiving a change of virtual viewpoint parameters of a first virtual viewpoint among virtual viewpoint parameters of a plurality of virtual viewpoints obtained; and
restricting, in a case where there are virtual viewpoint parameters of a second virtual viewpoint different from the first virtual viewpoint, which indicate a position and an orientation similar to a position and an orientation indicated by the virtual viewpoint parameters of the first virtual viewpoint, among a plurality of virtual viewpoint parameters obtained, the change of the virtual viewpoint parameters of the first virtual viewpoint received to a change that causes the virtual viewpoint parameters of the first virtual viewpoint to be no longer similar to the virtual viewpoint parameters of the second virtual viewpoint.

18. An image processing system comprising:
the information processing apparatus according to claim 1; and
an image processing apparatus that obtains virtual viewpoint parameters from the information processing apparatus and generates a virtual viewpoint image based on the obtained virtual viewpoint parameters and a plurality of captured images obtained from a plurality of imaging devices.

19. A non-transitory computer readable storage medium storing a program for causing a computer to perform an information processing method comprising:
obtaining virtual viewpoint parameters specifying each virtual viewpoint of a plurality of virtual viewpoints; and
notifying that a similar virtual viewpoint exists in a case where there are virtual viewpoint parameters of a second virtual viewpoint different from a first virtual viewpoint, which indicate a position and an orientation similar to at least a position and an orientation indicated by virtual viewpoint parameters of the first virtual viewpoint, among virtual viewpoint parameters of a plurality of virtual viewpoint parameters, which indicate a time identical to a time indicated by the virtual viewpoint parameter of the first virtual viewpoint among the plurality of virtual viewpoint parameters obtained.

20. A non-transitory computer readable storage medium storing a program for causing a computer to perform an information processing method comprising:
obtaining virtual viewpoint parameters specifying each virtual viewpoint of a plurality of virtual viewpoints;
receiving a change of virtual viewpoint parameters of a first virtual viewpoint among virtual viewpoint parameters of a plurality of virtual viewpoints obtained; and
restricting, in a case where there are virtual viewpoint parameters of a second virtual viewpoint different from the first virtual viewpoint, which indicate a position and an orientation similar to a position and an orientation indicated by the virtual viewpoint parameters of the first virtual viewpoint, among a plurality of virtual viewpoint parameters obtained, the change of the virtual viewpoint parameters of the first virtual viewpoint received to a change that causes the virtual viewpoint parameters of the first virtual viewpoint to be no longer similar to the virtual viewpoint parameters of the second virtual viewpoint.
